(19) United States
(12) Patent Application Publication
(10) Pub. No.: US 2017/0098421 A1
(43) Pub. Date: Apr. 6, 2017

(54) DISPLAY DEVICE, DISPLAY METHOD THEREOF AND DISPLAY SYSTEM

(71) Applicant: SAMSUNG ELECTRONICS CO., LTD., Suwon-si (KR)

(72) Inventor: Yong-hun SON, Suwon-si (KR)

(73) Assignee: SAMSUNG ELECTRONICS CO., LTD., Suwon-si (KR)

(21) Appl. No.: 15/235,692

(22) Filed: Aug. 12, 2016

(30) Foreign Application Priority Data
Oct. 1, 2015 (KR) 10-2015-0138320

(51) Int. Cl. G09G 3/36; G06F 3/14

(52) U.S. Cl. CPC G09G 3/3677; G06F 3/1446; G09G 2310/08; G09G 2320/0252; G09G 2310/0213; G09G 2300/026

(57) ABSTRACT

A display device configured to connect to another display device, display method thereof and display system are provided. An aspect of an exemplary embodiment relates to a display device including an interface configured to receive a plurality of input images, an image processor configured to process an image to be displayed on the display device among the received plurality of input images, and a display configured divide the image-processed image into an upper area and a lower area, display an upper image on the upper area in a first scanning direction, and display a lower image on the lower area in a second scanning direction which is opposite to the first scanning direction.

### CROSS-REFERENCE TO RELATED APPLICATION

This application claims priority from Korean Patent Application No. 10-2015-0138320, filed in the Korean Intellectual Property Office on Oct. 1, 2015, the disclosure of which is incorporated herein by reference in its entirety.

### BACKGROUND

1. Field

Methods and apparatuses consistent with exemplary embodiments relate to a display device, a display method thereof and a display system, and more particularly, to a display device which can resolve screen differences of a display system provided as a video wall, a display method thereof and a display system.

2. Description of Related Art

Generally, a display device displays an image on a screen. Various functions can be embodied by using such a display device. A display system including a plurality of display devices can cooperatively express one image on the plurality of display devices, for advertising, entertainment programs and sports programs.

For example, a display system including a plurality of display devices may be located in a place where a big screen is needed, such as in an exposition, a convention or the like. Each of the plurality of display devices that compose the display system can display an identical image, or each of the plurality display devices can display different images that can be combined as one entire image.

An image is sequentially displayed from an upper end of a display panel to a bottom end of the display panel, or from the bottom end to the upper end of the display panel. In this case, a time to display an image from the uppermost end of the panel to the lowermost end of the panel (and vice versa) is proportional to a frame rate of the panel. For example, when a frame rate is 60 Hz, it takes about 16 ms, and when a frame rate is 120 Hz, it takes about 8 ms. This time is called “a scanning delay.” However, the scanning delay causes a difference phenomenon which makes an image appear to be cut at an area where panels of two display devices meet, even though the two displays are synchronized. Specially, when displaying an image in which vertical lines quickly move horizontally, to the right and the left, such a difference is apparent, and is an interruption in providing an image.

### SUMMARY

Methods and apparatuses consistent with exemplary embodiments relate to a display device, a display method thereof and a display system.

An aspect of an exemplary embodiment relates to a display device configured to connect to another display device, the device including: an interface configured to receive a plurality of input images; an image processor configured to process an image to be displayed on the display device among the received plurality of input images; and a display configured to divide the image-processed image into an upper area and a lower area, display an upper image on the upper area in a first scanning direction, and display a lower image on the lower area in a second scanning direction which is opposite to the first scanning direction.

The display may be further configured to alternately perform a first scanning on the upper area and a second scanning on the lower area.

The display may include: a plurality of pixel lines in a matrix form; a first timing controller configured to apply a first driving signal to upper pixel lines among the plurality of pixel lines in the first scanning direction; and a second timing controller configured to apply a second driving signal to lower pixel lines among the plurality of pixel lines in the second scanning direction.

The display may further include a first driver and a second driver, wherein each of the plurality of pixel lines receives a first driving signal from the first driver and a second driving signal from the second driver, wherein the first timing controller is configured to provide the first driving signal to the plurality of pixel lines through the first driver, and wherein the second timing controller is configured to provide the second driving signal to the plurality of pixel lines through the second driver.

The first timing controller may be further configured to apply a first driving signal to odd-numbered sections of a clock signal of the display device, and the second timing controller may be further configured to apply a second driving signal to even-numbered sections of the clock signal of the display device.

The clock signal may be a vertical synchronization signal.

According to an aspect of another exemplary embodiment, there is provided a display method of a display device configured to connect to another display device, the method including: receiving a plurality of input images; processing an image to be displayed on the display device among the received plurality of input images; dividing the image-processed image into an upper area and a lower area; and displaying an upper image on the upper area in a first scanning direction and displaying a lower image on the lower area in a second scanning direction which is opposite to the first scanning direction.

The displaying may include alternately performing a first scanning on the upper area and a second scanning on the lower area.

The displaying may include applying a first driving signal to odd-numbered sections of a clock signal in the upper area of the display device, and applying a second driving signal to even-numbered sections of the clock signal in the lower area of the display device.

According to an aspect of yet another exemplary embodiment, there is provided a display system including: a plurality of display devices; and a controller configured to receive an input image signal, segment the input image signal into a plurality of segmented image signals, and provide each of the plurality of segmented image signals to a corresponding display device of the plurality of display devices,

wherein each of the plurality of display devices is configured to divide a received image corresponding to the provided corresponding image signal into an upper area and a lower area, display an upper image on the upper area in a first scanning direction and display a lower image on the lower area in a second scanning direction which is opposite to the first scanning direction.

### BRIEF DESCRIPTION OF THE DRAWINGS

FIGS. 1 and 2 are views illustrating a display system including a plurality of display devices according to an exemplary embodiment;

FIG. 3 is a view illustrating a display system according to another exemplary embodiment;

FIG. 4 is a schematic block diagram illustrating a configuration of a display device according to an exemplary embodiment;

FIG. 5 is a block diagram illustrating a detailed configuration of a display illustrated in FIG. 4;

FIG. 6 is a view illustrating an operation principle of an LCD panel;

FIGS. 7A and 7B are views illustrating an operation of a display device according to an exemplary embodiment;

FIGS. 8A and 8B are views illustrating an operation of a display device;

FIGS. 9A and 9B are views illustrating an operation of a display device according to an exemplary embodiment; and

FIG. 10 is a flow chart illustrating a display method of a display device according to an exemplary embodiment.

### DETAILED DESCRIPTION OF EXEMPLARY EMBODIMENTS

Certain exemplary embodiments are described in greater detail below with reference to the accompanying drawings. In the following description, if it is determined that a specific description on a known function or element may obscure the gist of the present disclosure unnecessarily, the specific description is omitted. The terms described in the disclosure are terms which are defined with a consideration of functions disclosed in the disclosure, and the terms may vary according to a user, an operator or a practice. Therefore, the terms in the disclosure should be defined based on the overall contents of the disclosure.

Expressions including ordinal numbers such as “first”, “second”, and so on as used herein may be used for describing a variety of elements, but the elements should not be limited by such expressions. The expressions mentioned above are used with a sole purpose of distinguishing one element from another. For example, without departing from the scope of the present disclosure, a “first element” may be named a “second element”, or similarly, the “second element” may be named the “first element.” The term “and/or” includes a combination of a plurality of related and described items or one item between or among a plurality of related and described items.

The terms in the disclosure are used for explaining exemplary embodiments and the terms are not intended to limit and/or restrict the disclosure. A singular expression used herein includes a plural expression, unless specified otherwise in the context. Terms “include” and “have” in the exemplary embodiments are to designate an existence of a feature, a number, a stage, an operation, a constituent element, a component described in the specification or a combination of thereof. The terms should not be understood to previously exclude a further existence of a feature, a number, a stage, an operation, a constituent element, a component or more than one different from the feature, the number, the stage, the operation, the constituent element or the component, or an additional possibility.

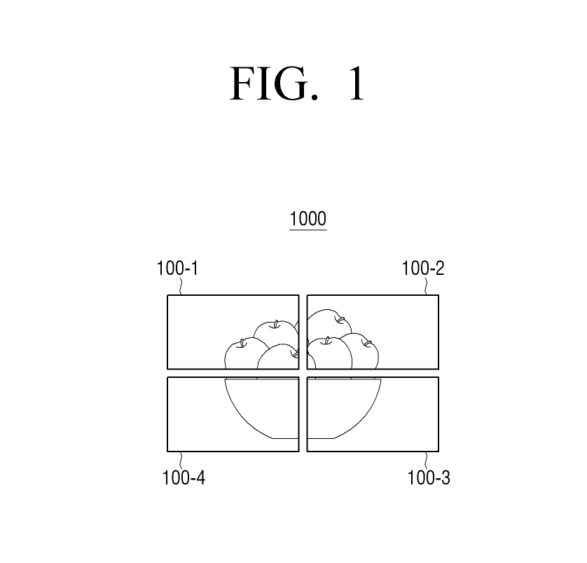

FIG. 1 is a view for illustrating a display system 1000 including a plurality of display devices according to an exemplary embodiment.

The display system 1000 may include a plurality of display devices 100-1, 100-2, 100-3, 100-4, and each of the plurality of display devices may display an identical image at the same time or may display different images in order to make an entire image.

Each of the display devices 100-1, 100-2, 100-3, 100-4 composing the display system 1000 may divide an image into an upper area and a lower area. An upper image may be displayed on the upper area in a first scanning direction (for example, from the top to the bottom) and a lower image may be displayed on the lower area in a second scanning direction (for example, from the bottom to the top) which is opposite to the first scanning direction.

Each of the display devices 100-1, 100-2, 100-3, 100-4 may alternately process an image data at the upper area and the lower area of a panel. For example, when the panel of the display device 100 has n pixel lines and the pixel lines from the uppermost line to the lowermost line are expressed as a first line to an n line, the display device 100 may process a data in order of the first line, the n line, a second line and an n-1 line. In other words, the data processing starts from the outermost lines (the top and the bottom) and the data processing ends at the center of the panel.

FIG. 1 illustrates that one image is displayed by four display devices 100-1, 100-2, 100-3, 100-4 simultaneously. For another example, four displays 100-1, 100-2, 100-3, 100-4 may respectively display one image at the same time. The source of each image displayed on the display devices 100-1, 100-2, 100-3, 100-4 may be one of the four display devices 100-1, 100-2, 100-3, 100-4.

For example, a first display device 100-1 may consecutively transmit an image stored in the first display device 100-1 to a second display device 100-2, a third display device 100-3 and a fourth display device 100-4 so that an entire image to be displayed on the four display devices 100-1, 100-2, 100-3, 100-4.

When the display system 1000 of the chain configuration is used, there are advantages of unification and simplification on a circuit structure and cost saving effect comparing to a parallel structure. However, because a delay occurs when an image signal passes each of the display devices, it may take different time for the display devices 100-1, 100-2, 100-3, 100-4 composing the display system 1000 to display images.

However, according to an exemplary embodiment, the display system 1000 may set respectively different delay times in the display devices 100-1, 100-2, 100-3, 100-4 and the delay problem which occurs when an image signal passes the display devices 100-1, 100-2, 100-3, 100-4 may be resolved. In other words, by setting different delay time for each of the display devices 100-1, 100-2, 100-3, 100-4 and controlling images to be displayed after each of the delay times passes, the four display devices 100-1, 100-2, 100-3, 100-4 may display an entire frame at the same time. Therefore, time for images displayed on the four display devices 100-1, 100-2, 100-3, 100-4 comprising the display system 1000 may be synchronized.

Meanwhile, even though the explanation is based on the limitation that the four display devices 100-1, 100-2, 100-3, 100-4 are used, it is only for a convenience of the explanation and the display device 100 composing the display system 1000 is not limited thereto.

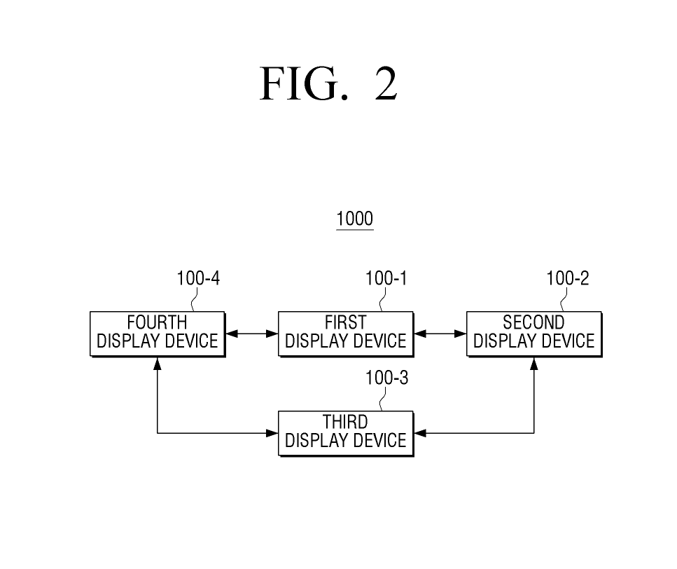

FIG. 2 is a view for illustrating the display system 1000 of a chain configuration according to an exemplary embodiment. Referring to FIG. 2, the plurality of display devices 100-1, 100-2, 100-3, 100-4 are connected to each other to transceive various information, commands and contents.

Even though FIG. 2 illustrates that each of the display devices 100-1, 100-2, 100-3, 100-4 are directly connected to the adjacent display devices, according to various exemplary embodiments, a connecting form is not limited thereto. For example, each display device may be directly connected to the other display devices.

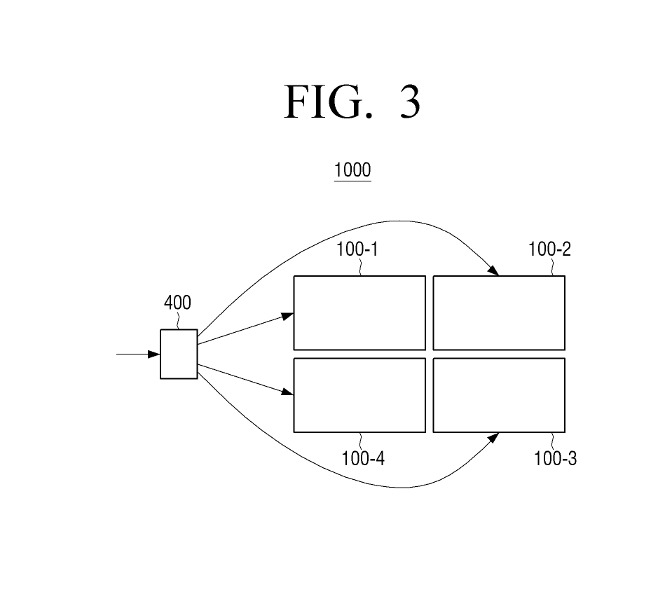

FIG. 3 is a view for illustrating the display system 1000 according to another exemplary embodiment. Referring to FIG. 3, the plurality of display devices 100-1, 100-2, 100-3, 100-4 may receive an input image in a parallel structure method.

A controller 400 which exists separately from the plurality of display devices 100-1, 100-2, 100-3, 100-4 may receive an input image, divide the input image and provide the divided images to the plurality of display devices 100-1, 100-2, 100-3, 100-4. Because the controller 400 processes images in a lump, there is no need for each of the plurality of display device 100-1, 100-2, 100-3, 100-4 to synchronize time for images.

As illustrated in FIG. 1, FIG. 3 illustrates that the display device 100 which composes the display system 1000 divides a provided image into an upper area and a lower area, displays an upper image on the upper area in a first scanning direction and display a lower image on the lower area in a second scanning direction which is opposite to the first scanning direction. By alternately performing a first scanning and a second scanning, the display device 100 may prevent a difference phenomenon from occurring on a part which is connected to another display device.

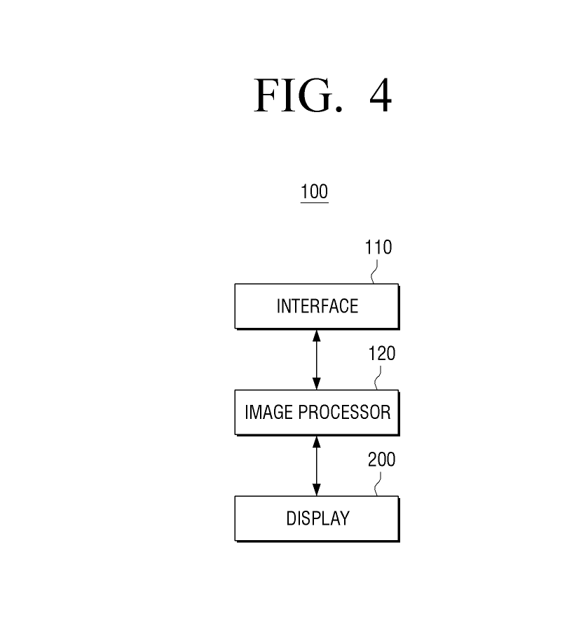

FIG. 4 is a schematic block diagram for illustrating a configuration of the display device 100 which composes the display system 1000 by being connected to at least one of another display device according to an exemplary embodiment.

FIG. 4 illustrates that the display device 100 according to an exemplary embodiment includes an interface 110, an image processor 120 and a display 200.

The interface 110 may receive an input image from an external. For example, the interface 110 may receive input images from an external server or another display device. The interface 110 may transmit the received input images to the another display device. The interface 110 also may transceive an input image through various communication methods such as an wired communication method and an wireless communication method.

The image processor 120 may process an image which is to be displayed on the display device 100 among the received input images. For example, the image processer 120 may perform signal processing with respect to an image signal and an audio signal input from the interface 110, such as video decoding, video scaling and audio scaling.

The display 200 may display an image which was processed. For example, the display 200 may display one image among images which were divided on basis of a position on which the display device 100 is disposed in the display system 1000. For example of the display system 1000 of 2×2, the display 200 which is positioned at an upper left end of the display device 100 may display an upper left image among four divided images.

The display 200 may scan a frame by alternately scanning one pixel line from the top of the frame, scanning one pixel line from the bottom, scanning another pixel line from the top again and scanning another pixel line from the bottom again.

For example, the display 200 may divide an image-processed image into an upper area and a lower area, display an image on the upper area in a first scanning direction and display an image on the lower area in a second scanning direction (which is the opposite direction to the first scanning direction). Also, the display 200 may alternately perform a first scanning on the upper area and a second scanning on the lower area.

For this, the display device 100 according to an exemplary embodiment may include two timing controllers 220-1, 220-2 and two drivers 300-1, 300-2. For example, the display 200 may include a first timing controller 220-1 which applies a driving signal in the first scanning direction through a first driver 300-1 and a second timing controller 220-2 which applies a driving signal in the second scanning direction through a second driver 300-2.

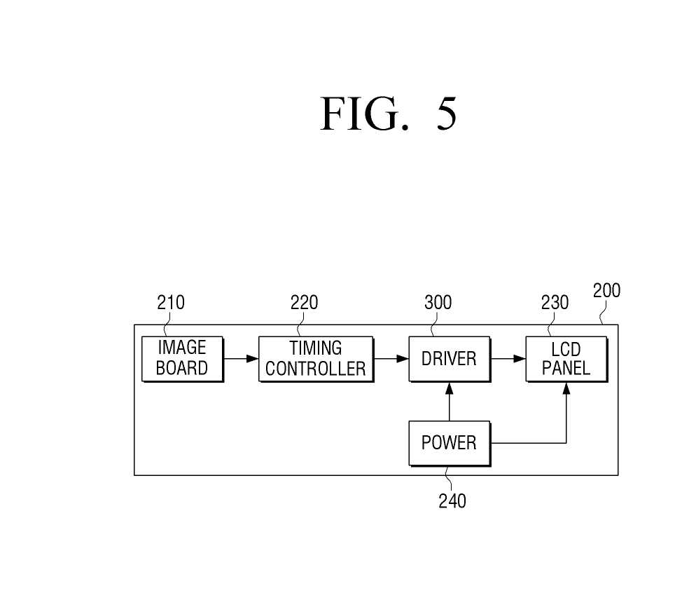

Hereinafter, an operation of the display 200 is explained in more detail with reference to FIG. 5.

FIG. 5 illustrates that the display 200 includes an image board 210, a timing controller 220, an LCD panel 230, a power 240 and a driver 300. The display device 100 according to an exemplary embodiment may include two timing controllers 220-1, 220-2 and two drivers 300-1, 300-2.

On the image board 210, a circuit or chips for processing an image and for controlling overall operations of the display may be disposed. Specifically, the image board 210 may generate an RGB image signal and an input controlling signal (DE, Hsync, Vsync, MCLK) regarding an image-processed image. Herein, the input controlling signal may include a data enable signal (DE), a horizontal synchronization signal (Hsync), a vertical synchronization signal (Vsync) and a main clock signal (MCLK).

The image board 210 may transmit a processed image signal to the timing controller 220.

The timing controller 220 may generate a driving control signal which corresponds to the processed image signal. Specifically, the timing controller 220 may generate a data signal by processing an input RGB image signal.

The timing controller 220 may generate a gate driving control signal and a source driving control signal by processing the input controlling signal. In other words, the driving control signal may include a data signal, a gate driving control signal and a source driving control signal. The timing controller 220 may transmit the generated data signal and the source driving control signal to a source driver 320, and transmit the gate driving control signal to a gate driver 310.

Herein, the timing controller 220 may transmit the driving control signal to the driver 300 by using one interface among a Reduced Swing Differential Signaling (RSDS), a Low-Voltage Differential Signaling (Mini-LVDS), a Point to Point Differential Signaling (PPDS), a LVDS, an Advanced Intra-Panel Interface (AiPi), Samsung Video Digital Link (SVDL) and V-by-One (V×1).

A liquid-crystal penetration rate of the LCD panel 230 may change according to an applied voltage. Specifically, the LCD panel 230 may have a liquid crystal layer between two glass substrates and include m×n crystal cells (Clc) in which m data lines and n data lines are disposed in a matrix form by a crossing structure.

Specifically, on a lower glass substrate of the LCD panel 230, data lines, gate lines, TFTs and pixel electrodes and a storage capacitor of crystal cells (Clc) which are connected to the TFTs may be formed. On the lower glass substrate of the LCD panel 230, line-on glass wires which transmit a data, a data timing control signal and a voltage to drive may be formed among the source COFs. For example, an electrode connected to a TFT gate may be a transparent electrode such as indium tin oxide (ITO) electrode.

On an upper glass substrate of the LCD panel 230, a color filter and a common electrode may be disposed.

The power 240 may generate gamma power (VDD) and common power which are used in the LCD panel 230 and the driver 300. The power 240 may generate power by including the timing controller 220 and the driver 300 and by being constructed as a DCDC circuit and/or a Low Drop Out (LDO) circuit.

The driver 300 may drive the LCD panel 230 according to a driving control signal. Specifically, the driver 300 may generate a voltage to be applied corresponding to the driving control signal and provide the voltage to the LCD panel 230.

The driver 300 may include the source driver 320 and the gate driver 310. Each of the source driver 320 and the gate driver 310 may be embodied as an integrated circuit (IC). For example, the source driver 320 may control an image data (Hsync) to be displayed, and the gate driver 310 may control a clock signal (Vsync).

When the source driver 320 and the gate driver 310 transmit a current to the TFT gate of the LCD panel 230 through a transparent electrode, the TFT gate opens and an image data is displayed. When considering one image frame as a unit, motions by which the TFT gate opens are consecutively carried out according to a Vsync signal.

An operation of the TFT gate is not independent due to a panel structure, when one driver 300 is used, the display 200 can only sequentially scan in a single scanning direction. When scanning in a direction opposite to the scanning direction (a reverse scan), there is a problem that a pixel cannot be charged and thus, the display method that the display 100 alternately scans the top and the bottom according to an exemplary embodiment cannot be embodied.

The display device 100 according to an exemplary embodiment may alternately scan a plurality of pixel lines of the LCD panel 230 up and down by including two timing controllers 220-1, 220-2 and two drivers 300-1, 300-2. It is advisable that two electrodes (for example, ITO electrodes) are prepared for each timing controller and driver. However, the number of the timing controller 220 and the driver 300 are not limited two.

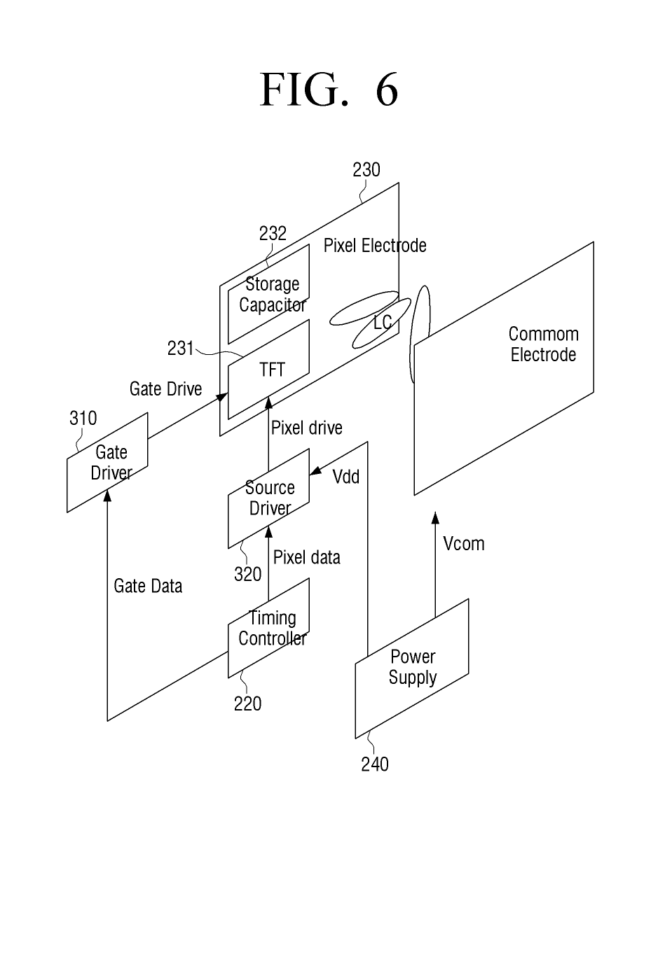

FIG. 6 is a view for illustrating an operation principle of an LCD panel. Even though the explanation is based on one timing controller 220 and one driver 300, the display device 100 according to an exemplary embodiment is equipped with two timing controllers 220-1, 220-2 and two drivers 300-1, 300-2.

The timing controllers 220-1, 220-2 may be disposed on the image board 110 and generate a driving control signal which corresponds to a processed image. In other words, the timing controllers 220-1, 220-2 may control operations of the LCD panel 230 and a backlight by using such a driving control signal. For example, timing controllers 220-1, 220-2 may be respectively disposed on an upper end and a lower end of the image board 110 and may be disposed together at one side.

According to an exemplary embodiment, the timing controller 220 may generate a data signal by processing an input RGB image signal. The timing controller 220 may process an input controlling signal, and generate a gate driving control signal and a source driving control signal by processing the input controlling signal.

The timing controller 220 may transmit the generated data signal and the source driving control signal to the source driver 320, and transmit the gate driving control signal to the gate driver 310.

Herein, the timing controller 220 may transmit a driving control signal to the driver 300 by using one interface among a Reduced Swing Differential Signaling (RSDS), a Low-Voltage Differential Signaling (Mini-LVDS), a Point to Point Differential Signaling (PPDS), a LVDS, an Advanced Intra-Panel Interface (AiPi), Samsung Video Digital Link (SVDL) and V-by-One (V×1).

The first timing controller 220-1 may provide a driving control signal to a plurality of pixel lines through the first driver 300-1. The second timing controller 220-2 may provide a driving control signal to a plurality of pixel lines through the second driver 300-2.

For example, the first timing controller 220-1 may control the first driver 300-1 to apply a driving signal for upper pixel lines among the plurality of pixel lines in a first scanning direction (from the upper end to the lower end). The second timing controller 220-2 may control the second driver 300-2 for lower pixel lines among the plurality of pixel lines in a second scanning direction (from the lower end to the upper end).

For example, the first timing controller 220-1 may apply a driving signal to odd-numbered sections of a clock signal and the second timing controller 220-2 may apply a driving signal of the clock signal to even-numbered sections so that the display 200 may alternately display an image on the upper pixel lines and the lower pixel lines. Here, the clock signal may be a vertical synchronization signal (Vsync).

The driver 300 may drive the LCD panel 230 according to a driving control signal. The driver 300 may include the source driver 320 and the gate driver 310. The source driver 320 may convert a data signal provided from the timing controller 220 to an analog signal and output the signal through data lines. The gate driver 310 receives an input of a gate driving control signal and drives gate lines.

The LCD panel 230 may display a screen which corresponds to an image signal which was driven and input by the driver 300. Specifically, the LCD panel 230 may include a plurality of pixel lines which are disposed in a matrix form defined by the gate lines and the data lines which cross each other.

The power 240 generates and provides common power that the LCD panel 230 uses. Herein, the common power is power which is applied to a common electrode of the LCD panel 230 and commonly, ½ power of gamma power is applied.

The power 240 generates and provides gamma power that the driver 300 uses. Herein, the gamma power is a voltage which is used when the driver 300 makes a voltage to be applied, and the gamma power has a voltage level which is greater than or at least the same as the ceiling value of a voltage to be applied which is generated by the driver 300.

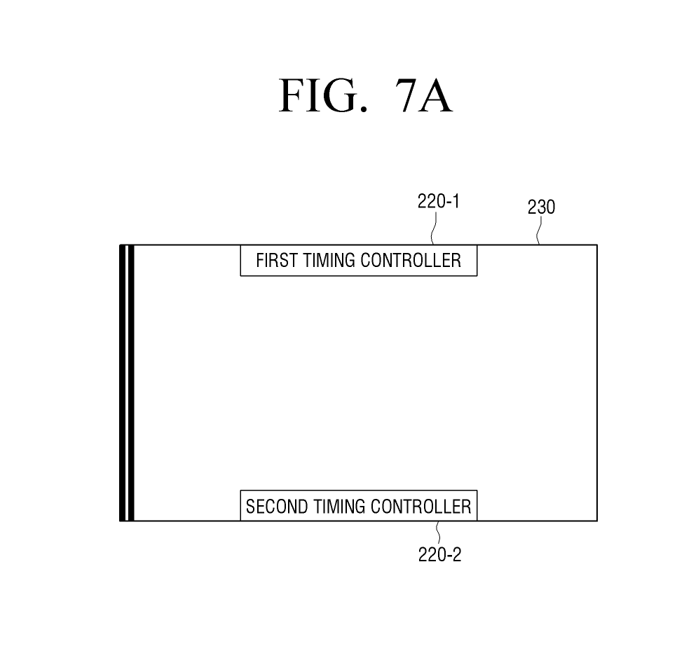

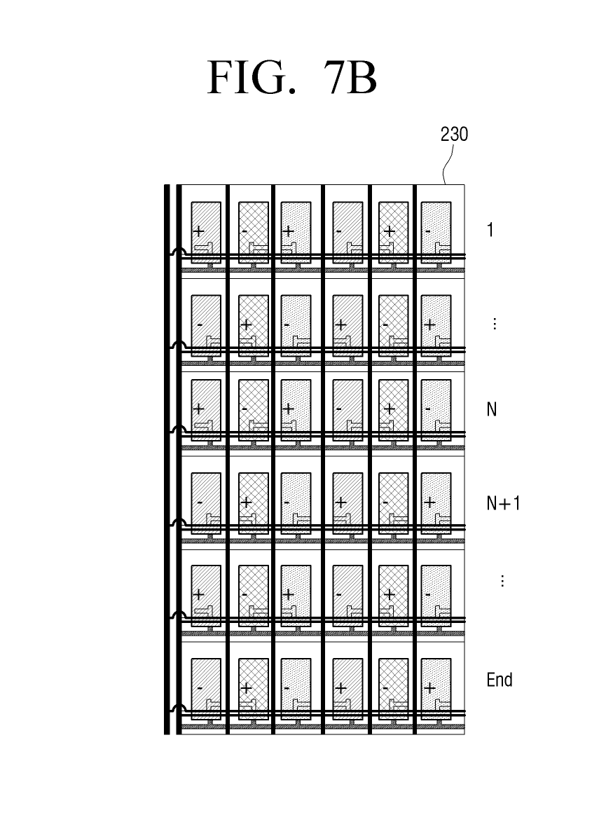

FIGS. 7A and 7B are views for illustrating an operation of the display device 100 according to an exemplary embodiment.

FIG. 7A illustrates that the first timing controller 200-1 is disposed on an upper end of the LCD 230 and the second timing controller 200-2 is disposed on a lower end of the LCD panel 230. Two lines illustrated on the left in FIG. 7A indicate two electrode lines. For example, one of the two ITO electrodes (transparent electrodes) connects the first timing controller (and the first driver) and the plurality pixel lines and the other electrode connects the second timing controller (and the second driver) and the plurality pixel lines.

FIG. 7B illustrates that the LCD panel 230 includes 2N pixel lines. For example, an upper area may be an area from pixel line 1 to pixel line N, and a lower area may be an area from pixel line N+1 to pixel line 2N (End). Each pixel may include three light sources which can indicate R, G and B.

For example, the first timing controller 220-1 may apply a signal which drives a TFT to pixel lines in order from pixel line 1 to pixel line N (in a first scanning direction) by controlling the first gate driver 310-1. When the TFT is turned on, the first timing controller 220-1 may input an image signal in the first scanning direction by controlling the first source driver 320-1.

On the contrary, the second timing controller 200-2 may apply a signal which drives the TFT on the pixel line in order from pixel line 2N (End) to pixel line N+1 (in a second scanning direction) by controlling the second gate driver 310-2. When the TFT is turned on, the second timing controller 220-2 may input an image signal in the second scanning direction by controlling the second source driver 320-2.

By the first timing controller 220-1 and the second timing controller 220-2 alternately applying a driving signal, the display 200 may display an image signal in order of pixel lines 1, 2N, 2, 2N−1, . . . , N−1, N+2, N, N+1.

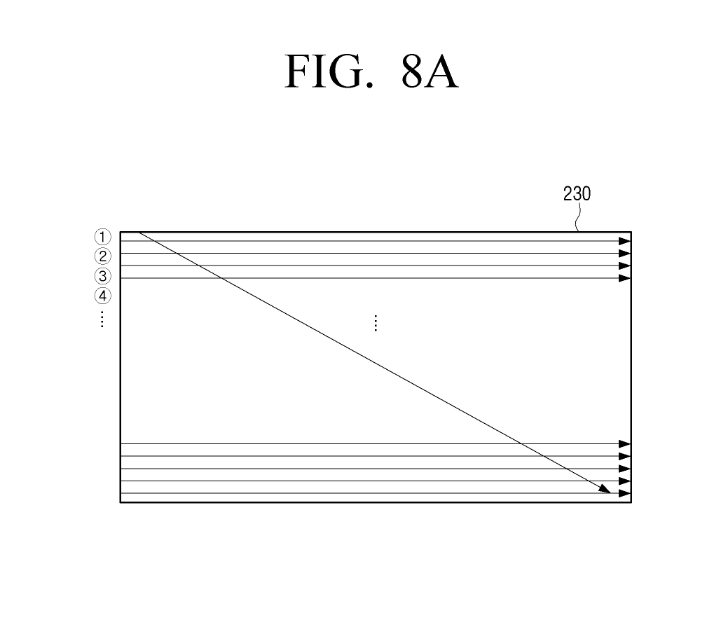

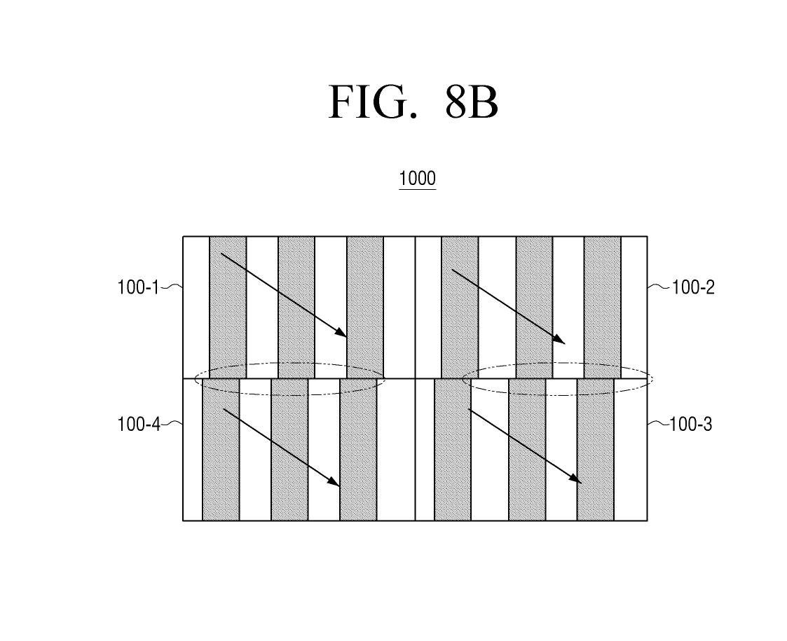

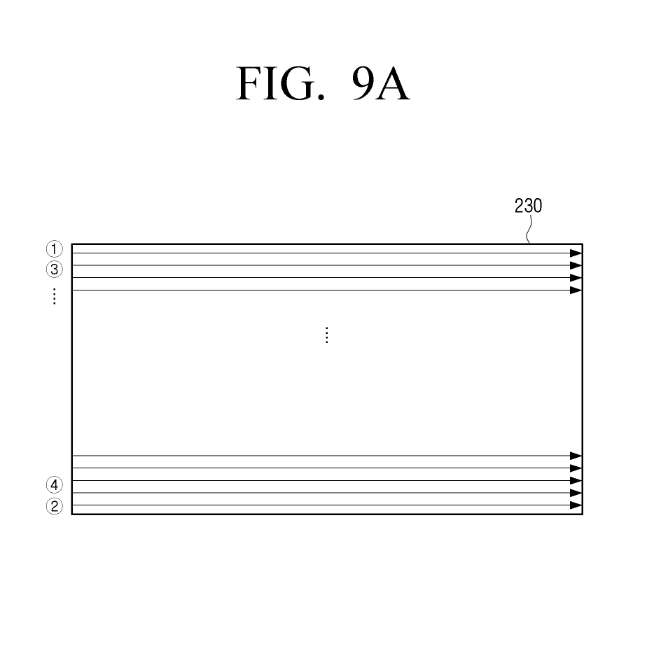

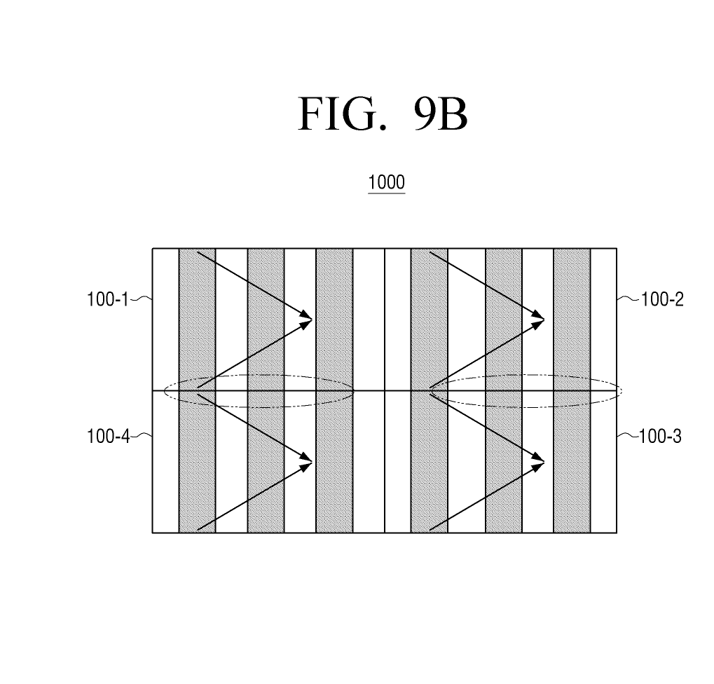

FIGS. 8A, 8B, 9A and 9B are views for illustrating a clear difference between an operation of an existing display device and an operation according to an exemplary embodiment.

The existing display device consecutively scans a plurality of pixel lines as illustrated in FIG. 8A. Accordingly, difference phenomena occur at parts where the first display device 100-1 and the fourth display device 100-4 are connected and where a second display device 100-2 and the third display device 100-3 are connected as illustrated in FIG. 8B.

However, the display device 100 according to an exemplary embodiment may alternately scan pixel lines of an upper end and pixel lines of a lower end. Accordingly, as illustrated in FIG. 9B, a difference phenomenon occurs neither at the part where the first display device 100-1 and the fourth display device 100-4 are connected not at the part where a second display device 100-2 and the third display device 100-3 are connected.

In case of an existing scanning, a difference phenomenon occurs because of a scanning delay which is a time difference between the time in which pixel lines of the uppermost end are scanned and the time in which pixel lines of the lowermost end are scanned.

FIG. 9B illustrates that a pixel line of the lowermost end of the first display device 100-1 is scanned for the second time, and a pixel line of the uppermost end of the fourth display device 100-4 is scanned for the first time. Accordingly, a scanning delay is reduced from a unit of ms to a unit of μs. In other words, only a little scanning delay occurs, which pertains to a difference phenomenon which cannot be observed by bare eyes.

For example, in case of an existing consecutive scanning, the scanning may be carried out by a display device located on an upper end scanning from a pixel line on the lowermost end and a display device located on a lower end scanning from a pixel line on the uppermost end. In this case, a difference phenomenon between the upper display device and the lower display device may be resolved even with the existing consecutively scanning method.

However, the existing method only pertains to a method which was conceived because both of a normal direction scanning and a reverse direction scanning that the display device 100 according to an exemplary embodiment performs cannot be performed. Also, with an entire video wall, there exists a problem that a difference of a scanning time for an upper end and a scanning time for a lower end gets bigger.

Also, with the existing method, even though the difference phenomenon on a part where an upper display device and a lower display device are connected can be resolved, a difference phenomenon in a single display device cannot be resolved. The display device 100 according to an exemplary embodiment has an effect to reduce a delay time even in a single display device.

The display device 100 according to an exemplary embodiment may reduce a scanning delay time to the half by scanning the upper area and the lower area at the same time through the two timing controllers 220-1, 220-2 and the two drivers 300-1, 300-2. For example, when a frame rate is 60 Hz, in an existing single display device, about 16 ms scanning delay occurs but in the display device 100 according to an exemplary embodiment, about 8 ms scanning delay which is the half of 16 ms scanning delay occurs.

In other words, it is not a difference between a pixel line on the uppermost end and a pixel line on the lowermost end in the display device 100 but it is a difference between a pixel line on the uppermost end and a pixel line on the center or a difference between a pixel line on the lowermost end and the pixel line on the center. Therefore, only about a half of a scanning delay occurs. Because about half of a scanning delay occurs, a user may not perceive a difference phenomenon when watching a screen. For example, when a frame rate is 120 Hz, only about 4 ms scanning delay occurs in a single display device according to an exemplary embodiment, and thus a user cannot perceive such a difference with bare eyes.

When a display system such as a video wall is embodied by using the display device 100 according to various exemplary embodiments, a difference phenomenon which looks like a screen cut may be resolved. Accordingly, an image may be provided to a user without a difference phenomenon causing an inconvenience in watching the image.

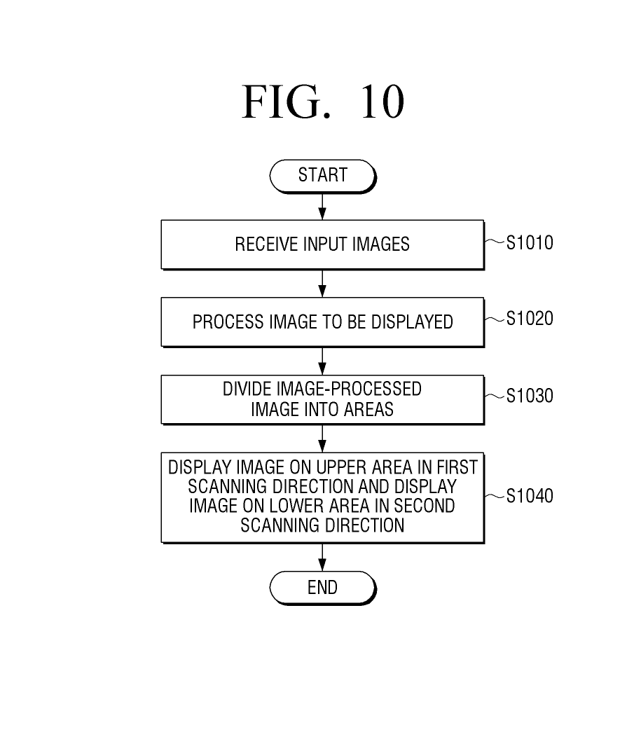

FIG. 10 is a flow chart for illustrating a display method of the display device 100 according to an exemplary embodiment.

The display device 100 which composes a display system by being connected to at least one of another display device may receive input images (S1010). The display device 100 may process an image to be displayed among the received input images (S1020). For example, according to a relation of disposition with the another display device which composes the display system 1000, the display device 100 may determine an image to be displayed.

The display device 100 may divide the image-processed image into an upper area and a lower area (S1030), and this is to divide operation areas of two timing controllers and two drivers. For another example, without dividing an image into areas, each of the two timing controllers may alternately apply a driving signal to each of pixel lines from the uppermost end to the lowermost end until driving signals are applied to all pixel lines.

The display device 100 may display an image on the upper area in a first scanning direction and display an image on the lower area in a second scanning direction which is opposite to the first scanning direction (S1040). The display device 100 may resolve the difference phenomenon by alternately performing a first scanning on the upper area and a second scanning on the lower area. For example, the display device 100 may apply a driving signal to odd-numbered sections of a clock signal in the upper area and apply a driving signal to even-numbered sections of the clock signal in the lower area. For another example, the display device 100 may perform the first scanning and the second scanning at the same time.

The exemplary embodiments may be recorded in a computer-readable recording medium by being embodied as a program command which can be executed through various computer methods. The computer-readable recording medium may include a program command, a data file, a data configuration and a combination thereof. The program command recorded in the medium may be what is specially designed and configured for the disclosure or could be what is publically known to those who are in a computer software field. Examples of the computer-readable recording medium include magnetic media such as a hard disk, a floppy disk and a magnetic tape, optical media such as a CD-ROM and a DVD, magneto-optical medium such as a floptical disk and hardware devices which are specially configured to store and perform a program command such as a ROM, a RAM and a flash memory. In addition to a machine language code which is, for example, created by a compiler, examples of a program command include a high-level language code which can be executed by a computer by using an interpreter. The hardware device may be configured to operate as at least one software module to perform an operation of the disclosure, and vice versa.

As above, a few exemplary embodiments have been shown and described. The foregoing exemplary embodiments and advantages are merely exemplary, and are not to be construed as limiting. The present teaching can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A display device configured to connect to another display device, the device comprising:
an interface configured to receive a plurality of input images;
an image processor configured to process an image to be displayed on the display device among the received plurality of input images; and
a display configured to divide the image-processed image into an upper area and a lower area, display an upper image on the upper area in a first scanning direction, and display a lower image on the lower area in a second scanning direction which is opposite to the first scanning direction.

2. The device as claimed in claim 1, wherein the display is further configured to alternately perform a first scanning on the upper area and a second scanning on the lower area.

3. The device as claimed in claim 1, wherein the display comprises:
a plurality of pixel lines in a matrix form;
a first timing controller configured to apply a first driving signal to upper pixel lines among the plurality of pixel lines in the first scanning direction; and
a second timing controller configured to apply a second driving signal to lower pixel lines among the plurality of pixel lines in the second scanning direction.

4. The device as claimed in claim 3, wherein the display further comprises a first driver and a second driver,
wherein each of the plurality of pixel lines receives a first driving signal from the first driver and a second driving signal from the second driver,
wherein the first timing controller is configured to provide the first driving signal to the plurality of pixel lines through the first driver, and
wherein the second timing controller is configured to provide the second driving signal to the plurality of pixel lines through the second driver.

5. The device as claimed in claim 3, wherein the first timing controller is further configured to apply a first driving signal to odd-numbered sections of a clock signal of the display device, and
wherein the second timing controller is further configured to apply a second driving signal to even-numbered sections of the clock signal of the display device.

6. The device as claimed in claim 5, wherein the clock signal is a vertical synchronization signal.

7. A display method of a display device configured to connect to another display device, the method comprising:
receiving a plurality of input images;
processing an image to be displayed on the display device among the received plurality of input images;
dividing the image-processed image into an upper area and a lower area; and
displaying an upper image on the upper area in a first scanning direction and displaying a lower image on the lower area in a second scanning direction which is opposite to the first scanning direction.

8. The method as claimed in claim 7, wherein the displaying comprises alternately performing a first scanning on the upper area and a second scanning on the lower area.

9. The method as claimed in claim 7, wherein the displaying comprises applying a first driving signal to odd-numbered sections of a clock signal in the upper area of the display device, and applying a second driving signal to even-numbered sections of the clock signal in the lower area of the display device.

10. A display system, comprising:
a plurality of display devices; and
a controller configured to receive an input image signal, segment the input image signal into a plurality of segmented image signals, and provide each of the plurality of segmented image signals to a corresponding display device of the plurality of display devices,
wherein each of the plurality of display devices is configured to divide a received image corresponding to the provided corresponding image signal into an upper area and a lower area, display an upper image on the upper area in a first scanning direction and display a lower image on the lower area in a second scanning direction which is opposite to the first scanning direction.
